(19) United States
(12) Patent Application Publication
(10) Pub. No.: US 2018/0130308 A1
(43) Pub. Date: May 10, 2018

(54) SYSTEMS AND METHODS FOR ENHANCING GAMING PAYOUTS USING GRID INTERACTIONS

(71) Applicant: KING SHOW GAMES, INC., Minnetonka, MN (US)

(72) Inventors: Bradley BERMAN, Minnetonka, MN (US); Jacob LAMB, Maple Grove, MN (US); Anthony RATH, Minnetonka, MN (US); Gregg PALMER, Lake Oswego, OR (US)

(21) Appl. No.: 15/807,084

(22) Filed: Nov. 8, 2017

Related U.S. Application Data
(60) Provisional application No. 62/419,421, filed on Nov. 8, 2016.

(51) Int. Cl. G07F 17/32

(52) U.S. Cl. CPC G07F 17/3267; G07F 17/3269; G07F 17/3211; G07F 17/3209; G07F 17/3244

(57) ABSTRACT

Systems, apparatuses and methods for enhancing gaming payouts with interacting gaming grid events. In one embodiment, a gaming grid is populated with symbols, and a plurality of those symbols are changed to enhanced symbols that increase the payout capabilities. Depending on an interaction state of the enhanced symbols relative to one another on the grid, one or more of the enhanced symbols may be changed to further enhanced symbols in order to provide an even greater increase in payout capabilities. The interaction states may involve the proximity of the enhanced symbols relative to one another.

### FIELD

This disclosure relates generally to games, and more particularly to gaming systems, apparatuses and methods for enhancing gaming payouts with interacting gaming grid events.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and provide advantages over the prior art.

### SUMMARY

The present disclosure is directed to systems, apparatuses, computer-readable media, and/or methods that are configured to enhance gaming payouts with interacting gaming grid events. In one embodiment, a gaming grid is populated with symbols, and a plurality of those symbols are changed to enhanced symbols that increase the payout capabilities. Depending on an interaction state of the enhanced symbols relative to one another on the grid, one or more of the enhanced symbols may be changed to further enhanced symbols in order to provide an even greater increase in payout capabilities. The interaction states may involve the proximity of the enhanced symbols relative to one another.

In accordance with one embodiment, a game apparatus is provided for enhancing gaming awards in a slot game utilizing symbols in respective symbol locations of a symbol grid to determine payouts. The game apparatus includes at least a display, a user interface, a wager input device, and a processor. The display presents the symbol locations of the symbol grid, and the user interface includes a user input enabling players to initiate slot game events presented via the symbol array. An input device is structured to identify and validate player assets, and to permit players to play the slot game event when the player assets are provided. The processor is configured to present symbols, selected from a set of available symbols, in the symbol grid of the symbol locations, and to randomly position a plurality of wild indicators on the symbol locations of at least a portion of the symbol grid. The processor determines a state of interaction between the wild indicators; and associates different features with the symbol locations having the wild indicators depending on the state of interaction between each of the wild indicators.

In a more particular embodiment of such a game, the processor is configured to determine the state of interaction as a proximity of the wild indicators to one another. For example, the processor may determine the state of interaction as an adjacency of the wild indicators to one another, or as a stacking of the wild indicators at a common one of the symbol locations, etc. In one embodiment, the processor is further configured to associate increasingly higher payout modifiers with the symbol locations having the wild indicators as the distance between the wild indicators on the symbol grid decreases.

In another embodiment, the processor is configured to associate different values of multipliers with the symbol locations having the wild indicators depending on the state of interaction between each of the wild indicators. In another embodiment, the wild indicators are each assigned respective default multiplier values, and the processor is configured to associate the different features by updating the default multiplier values if the state of interaction between the wild indicators obtains a predefined state.

In another particular embodiment, the processor is configured to randomly position the wild indicators by randomly positioning overlay wild symbols on the symbol locations. In another embodiment, the processor is configured to randomly position the wild indicators by substituting the wild indicators for the symbols existing at the symbol locations of the wild indicators. In still another embodiment, the processor is configured to randomly position the plurality of wild indicators on a single column or “reel” of the slot game, where in yet other embodiments the processor is configured to randomly position the plurality of wild indicators in any of the symbol locations of the symbol grid.

Another embodiment involves the processor being configured to associate different features with the symbol locations having the wild indicators by spawning new randomly-positioned wild indicators if the state of interaction obtains a predefined state.

In another embodiment, a game apparatus is provided, for enhancing gaming awards in a slot game utilizing symbols in respective symbol locations of a symbol grid to determine payouts. The game apparatus includes at least a display, a user interface, a wager input device, and a processor. The display presents the symbol locations of the symbol grid, and the user interface includes a user input enabling players to initiate slot game events presented via the symbol array. An input device is structured to identify and validate player assets, and to permit players to play the slot game event when the player assets are provided. The processor is configured to populate a grid with symbols, randomly changing a plurality of symbols on the grid with first-level enhanced symbols, and depending on the proximity of the enhanced symbols relative to one another on the grid, changing one or more of the enhanced symbols to second-level enhanced symbols.

In another embodiment of such an apparatus, the first-level enhanced symbols are of higher gaming value than the symbols populating the grid, and the second-level enhanced symbols are of higher gaming value than the first-level enhanced symbols.

In some embodiments the processor is configured to determine the proximity of the enhanced symbols relative to one another on the grid, and to change one or more of the enhanced symbols to second-level enhanced symbols when the processor determines the proximity of the enhanced symbols to be in adjacent ones of the symbol locations. In another embodiment, the processor is configured to determine the proximity of the enhanced symbols relative to one another on the grid, and to change one or more of the enhanced symbols to second-level enhanced symbols when the processor determines the proximity of the enhanced symbols to be in adjacent ones of the symbol locations on the same visible portion of the slot game reel. In still another embodiment, the processor is configured to determine the proximity of the enhanced symbols relative to one another on the grid, and to change one or more of the enhanced symbols to second-level enhanced symbols when the processor determines the proximity of the enhanced symbols to be stacked in a common one of the symbol locations. One embodiment involves the second-level enhanced symbols having an increased number of the symbols than a number of the first-level enhanced symbols.

In another embodiment, a method for enhancing gaming payouts is provided. A slot game grid is populated with symbols, and a plurality of symbols on the grid are randomly changed with first-level enhanced symbols. The relative positions on the slot game grid of the first-level enhanced symbols is determined. If the relative positions of the first-level enhanced symbols are determined to be in adjacent ones of the symbol locations, the first-level enhanced symbols are updated to second-level enhanced symbols. If the relative positions of the first-level enhanced symbols are determined to be in a same one of the symbol locations, the first-level enhanced symbols are updated to third-level enhanced symbols. The slot game grid is analyzed to determine payouts in view of any of the symbols, the first-level enhanced symbols, the second-level enhanced symbols, and the third-level enhanced symbols.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIG. 3 is depicts an embodiment for providing an opportunity to enhance initial gaming results via symbol supplantation in a slot game context.

FIGS. 4A-4H depict representative examples of various game play grids and trigger conditions to provide a modified game play grid, which may provide an improved payout or result relative to the original symbol arrangement on the game play grid.

FIGS. 5A-5C depict embodiments where a trigger event causes the release or spawning of additional triggers to replace or supplement other symbols.

FIGS. 6A and 6B illustrate an example of how a symbol overlay as described herein can enhance gaming results based on symbol overlay interaction rules.

FIGS. 7A and 7B illustrate an embodiment where a predetermined number of symbol overlays are confined to or otherwise made available on a common reel.

FIGS. 8A and 8B depict alternative embodiments where overlay/replacement symbol interaction rules provide expanding block wild actions.

FIG. 9A depicts an embodiment including adjacent or overlaid symbols creating linearly expanding wild functions.

FIG. 9B shows an example where multiple overlay symbols or other triggers are provided at a single symbol location, and multiple interactions create a heightened grid enhancement.

FIG. 9C depicts an example where the interaction rules create a linearly expanding group of wild symbols with tiered modifiers.

FIGS. 9D and 9E illustrate examples where the interaction rules create a wild expansion and varying modifier values, where the overlay or other trigger symbols are not restricted to a single reel/column.

FIGS. 10A and 10B illustrate a representative embodiment of a poker game allowing enhanced gaming awards using random enhancers, which may be further enhanced due to their relative interaction with one another.

FIGS. 11A and 11B are block diagrams of representative alternative slot game apparatuses for using interactive enhancement elements in accordance with the disclosure.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” In the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for providing interacting game grid events in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that enables and utilizes an interaction of game grid events. For example, one embodiment involves a gaming grid populated with symbols, where some of those symbols are changed to enhanced symbols that increase the payout capabilities. Depending on an interaction state of the enhanced symbols relative to one another on the grid, one or more of the enhanced symbols may be changed to further enhanced symbols in order to provide an even greater increase in payout capabilities. The interaction states may involve the proximity of the enhanced symbols relative to one another. Some embodiments relate to a method of operating a gaming device that may include providing a set of N overlays or other triggering events that cause symbols appearing on a game grid associated with them (e.g., below the overlay) to become multiplier wilds, wherein as the overlays overlap or achieve adjacency, or other defined relationship, their multiplier values increase or are otherwise modified.

Numerous variations are possible in view of these and other embodiments of the inventive concept. Representative embodiments and variations are described herein, with some embodiments described with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, or other games of chance. Some of these other types of embodiments will be discussed below as variations to the examples illustrated. However, many other types of games can implement similar techniques and fall within the scope of the present teachings.

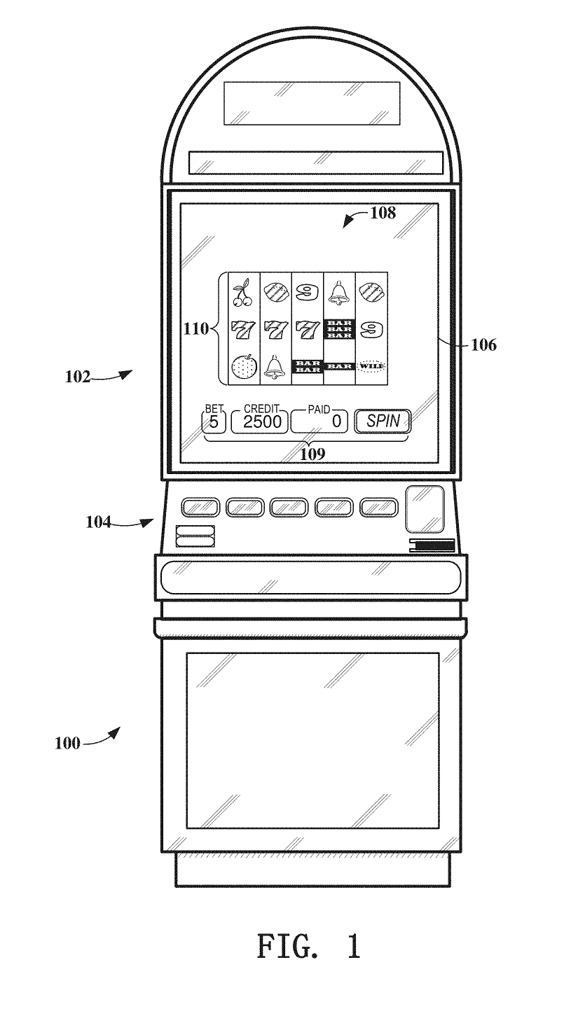

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touchscreen input, tactile input, and/or any other user input system or mechanism that allows the user to play and interact with the particular gaming activity.

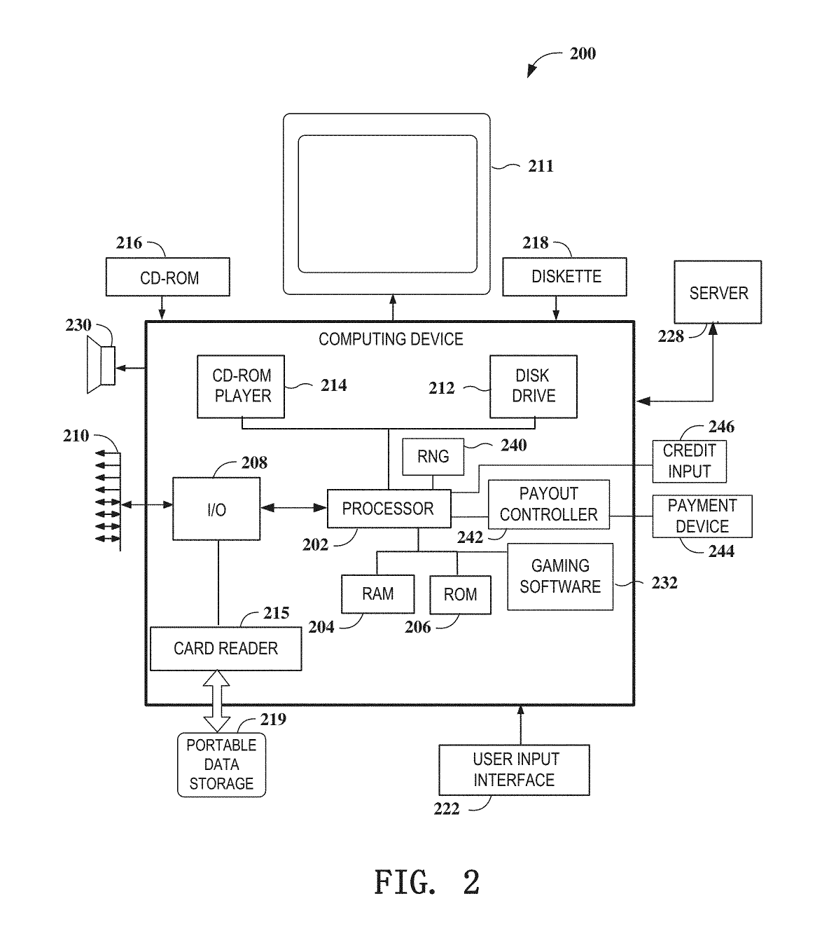

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as pay table information associated with a glass/plastic panel(s) on the gaming machine 100 and/or graphical images. The symbols or other indicia associated with the play of the game may be presented on an electronic display device or on mechanical devices associated with a mechanical display. Generally, in some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some example embodiments illustrated herein, the primary gaming portion 108 may display a grid (or equivalent arrangement) of game elements 110 or game element positions (also referred to herein as “reel stop positions”). As illustrated in the embodiment shown in FIG. 1, the grid includes three rows and five columns of game elements 110, which may form a game outcome(s) of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as pay tables, navigation controls, etc.

Although FIG. 1 illustrates a particular implementation of some of the embodiments of this invention in a casino or electronic gaming machine (“EGM”), one or more devices may be programmed to play various embodiments of the invention. The concepts and embodiments described herein may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example of a computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor, such as depicted by the representative central processing unit (CPU) 202, coupled to memory, such as random access memory (RAM) 204, and some variation of read-only memory (ROM) 206 or other persistent storage. The ROM 206 may also represent other types of storage media to store programs, such as programmable ROM (PROM), erasable PROM (EPROM or any technology capable of storing data). The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 that may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, or any other player assets, for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a pay table. The software 232 may include instructions to provide other functionality as known in the art or as described and shown herein.

The systems, apparatuses and methods operable via these and analogous computing and gaming devices can support gaming features as described herein.

Embodiments of the present concept include providing gaming devices, gaming systems, and methods of operating these devices or systems to provide game play that utilizes operations of providing interacting game grid events. In the context of a slot game, one embodiment involves presenting symbols in a grid of symbol locations, where the presented symbols are from a set of available symbols for the game. A plurality of wild indicators are randomly positioned on the symbol positions of at least a portion of the grid. A state of interaction between the randomly positioned wild indicators is determined, and different features are associated with the symbol locations having the wild indicators depending on the state of interaction between each of the randomly positioned wild indicators. In another embodiment, a method of operating a gaming device includes providing a set of N overlays that cause symbols appearing on a game grid below the overlays to become multiplier wilds, wherein as the overlays overlap or achieve adjacency, or other defined relationship, their multiplier values increase or are otherwise modified. These are merely representative, illustrative examples of the symbol-updating and enhancement functionality that is the focus of this disclosure.

It should be noted that the “wild indicators” referred to herein may be wild symbols, or other designating indicia identifying particular symbol locations as having a wild functionality. Also, in some embodiments, wild functionality may be replaced with other game features (e.g., high value symbols; a particular symbol; bonus indicators; free game indicators, etc.). Therefore, while exemplary embodiments may be described in terms of wild symbols or other wild functionality, the principles described herein are equally applicable to using overlays or other symbol replacement methodologies with desired functionality other than making the symbol locations “wild.”

Moreover, many embodiments may be described in terms of a slot game, where symbols are matched on paylines to determine payout awards. However, the principles described herein are equally applicable to other games of chance, as described herein and as will be readily apparent to those skilled in the art from the teachings herein.

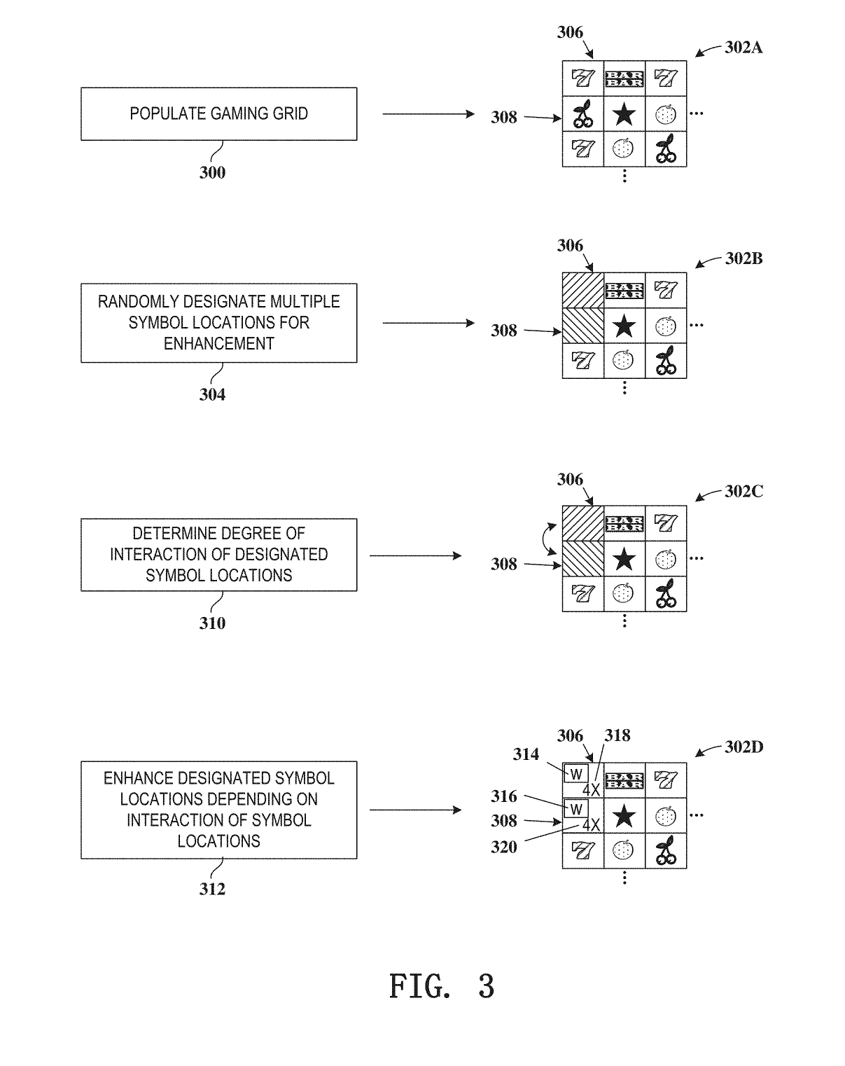

FIG. 3 is described in the context of such a slot game embodiment, and depicts an embodiment for providing an opportunity to enhance initial gaming results via symbol supplantation, or replacement in other embodiments. In this embodiment, a gaming grid comprising multiple symbol locations is populated 300. Gaming grid 302A depicts an example of a slot game with multiple symbol locations, of any desired size, that is capable of receiving symbols in the symbol positions. Gaming grid 302A depicts the state following initial placement of symbols in the symbol positions.

Multiple symbol locations are then randomly designated 304 for enhancement. This random designation may involve, for example, highlighting a plurality of symbol locations, overlaying new symbols on existing symbols, presenting special symbols initially in grid 302A, etc. In the illustrated embodiment, symbol locations 306 and 308 shown at grid 302B have been designated 304 as locations for symbol replacement. In one embodiment, the symbol locations 306 and 308 will be supplanted with wild functionality, such as wild symbols overlaid on the initially positioned symbols at symbol locations 306, 308.

In accordance with the principles described herein, a determination 310 is made regarding the degree of interaction between the randomly designated symbol locations. In other words, a determination 310 is made regarding some interaction between the randomly designated 304 symbol locations 306, 308 on grid 302C. This interaction may include a relative proximity of the randomly designated symbol locations, a comparison of the underlying symbols originally at the locations of the designated symbol locations, etc. In the illustrated embodiment, the interaction being considered is a relative proximity of the randomly designated symbol locations 306, 308 to one another, and their relative positions are adjacent in this example. Depending on the interaction of the randomly designated symbol locations, the symbols or functionality at those symbol locations is enhanced 312 or potentially enhanced, whether this results in a winning payout or not. In the example of grid state 302D, the original symbols at symbol locations 306 and 308 have been supplanted by new wild symbols 314, 316. Because of the adjacency of the target symbol locations 306, 308, game rules may provide an even greater enhancement opportunity, such as adding or increasing multiplier or other modifier values. In the illustrated embodiment, multipliers having a value of four (i.e. 4X multipliers) have been assigned to the two wild symbols positioned at the randomly designated symbol locations 306, 308 as a result of the relative proximity (in this example) of the designated symbol location 306, 308. As described in further embodiments below, other interactions may result in different levels of enhancement, such as further increasing multipliers if the symbol locations randomly selected are the same symbol location (e.g., a random selection of symbol locations selected the same symbol location multiple times).

The symbol grids that may be used in connection with the present disclosure may be any size or configuration. For example, a slot game may have three reels, four reels, five reels, nine reels, etc. The slot game grid may have physical reels or other symbol-changing mechanisms. Alternatively, the slot game grid may have an electronic/virtual grid where columns of reels are used, or any subset (e.g., individual reels) are randomized to populate the symbol grid. These and/or other types of manners of populating playing areas may be implemented in accordance with the principles described herein.

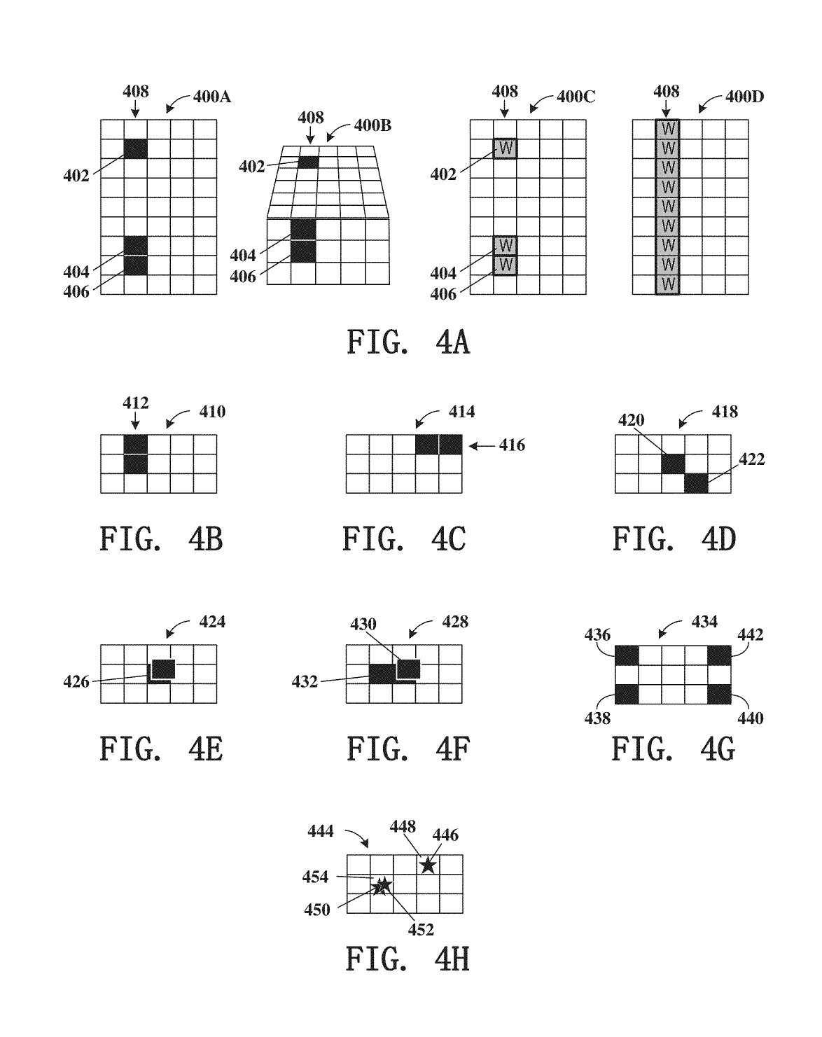

Regardless of the size, shape or configuration of the game play grid, the present disclosure contemplates determining trigger events relating to the interaction of specified symbol locations, and using rules to modify the game play grid depending on how the specified symbol locations (which may be specified by symbols associated with those symbol locations) relate to one another. FIGS. 4A-4H depict representative examples of various game play grids and trigger conditions to provide a modified game play grid, which may provide the player with an increased chance of winning (or winning a higher payout) relative to the original symbol arrangement on the game play grid.

FIG. 4A depicts a representative slot game grid 400A having nine rows and five columns (i.e. a 9×5 grid), which can be presented in any desired manner, including a three-dimensional 9×5 slot game grid 400B, etc. As previously noted, any size or configuration grid may be used, and the examples provided herein merely represent various sizes and configurations for purposes of facilitating an understanding of the principles described herein.

It is assumed that game symbols will be populated in the various symbol locations of the grid 400A/400B, and that a plurality of symbol location identifiers will be associated with respective symbol positions either before or after the grid is populated with symbols. In the illustrated embodiment, it is assumed that the randomly designated symbol locations will be on the same reel or column on any given spin, and are shown on reel 408 in this example. The original symbols, if any, positioned at the randomly designated symbol locations 402, 404 and 406 indicate symbol positions whose associated symbols will be modified, replaced, supplanted, or otherwise changed to provide the possibility of creating or improving a winning game result. For example, game rules may be established indicating that the randomly designated symbol locations 402, 404, 406 will have any associated symbol changed to or replaced by wild symbols (W), as noted at game grid 400C, where the randomly designated symbol locations 402, 404, 406 have been populated with wild (W) symbols. In one embodiment, the rules indicate that the wild (W) symbols at symbol positions 404, 406 may be awarded a modifier, such as a multiplier value (e.g., 4×) because the randomly designated symbol locations 404, 406 are adjacent to one another (i.e. meet a predetermined proximity rule). Therefore, this interaction, adjacent proximity in this example, may cause the wild symbols at symbol locations 404, 406 to be associated with a modifier (or a higher modifier) than a wild symbol at symbol location 402 that may not have had an interaction with another randomly designated symbol location.

Slot game grid 400D illustrates another possible result, based on a different rule for an adjacent interaction of two randomly designated symbol locations. In this example, the rule may indicate that at least two adjacent randomly designated symbol locations 404, 406 will cause a portion of, or in this example the entire reel/row 408, to be replaced with wild symbols (W). Other embodiments described below show that such expanding wilds may be awarded modifiers (e.g., multipliers), may have expansion limits less than boundary-to-boundary, may expand in other directions or multiple directions, etc.

Interaction rules may include positional adjacency as was depicted in FIG. 4A. FIGS. 4B, 4C and 4D depict representative manners of utilizing adjacency of the randomly designated symbol locations to potentially enhance game results. FIGS. 4B, 4C and 4D are depicted as 3×5 slot game grids, although the principles described in connection with these figures are applicable to any size slot grid.

FIG. 4B depicts vertical adjacency on a slot game grid 410, such as that described in connection with FIG. 4A. In embodiments where the rules allow the randomly designated symbol locations to be anywhere on the grid, the vertical alignment of the randomly designated symbol locations may merely be coincidental. In other embodiments, the rules may involve positioning the randomly designated symbol locations on one reel/column 412, where the reel receiving the randomly designated symbol locations may be the same for each gaming event (e.g., slot game spin), or may be allowed to systematically or randomly differ on each gaming event. Adjacent randomly designated symbol locations may result in any desired modification to the symbols therein, such as changing the symbols to wild symbols and providing associated multipliers (e.g., wild functionality with 2× multiplier), expansion of wild functionality to a block of wild symbols, linearly expanding wild symbols, or other desired result.

FIG. 4C depicts a horizontal adjacency embodiment, where randomly designated symbol locations are positioned on the same row 414 of the slot game grid 414. In embodiments where the rules allow the randomly designated symbol locations to be anywhere on the grid, the horizontal alignment of the randomly designated symbol locations may merely be coincidental. In other embodiments, the rules may involve positioning the randomly designated symbol locations on one row, where the reel receiving the randomly designated symbol locations may be the same for each gaming event (e.g., slot game spin), or may be allowed to systematically or randomly differ on each gaming event. Adjacent randomly designated symbol locations may result in any desired modification to the symbols therein, such as changing the symbols to wild symbols and providing associated multipliers (e.g., wild functionality with 2× multiplier), expansion of wild functionality to a block of wild symbols, linearly expanding wild symbols, or other desired result.

FIG. 4D depicts a diagonal adjacency embodiment on the slot game grid 418. The game rules may establish that randomly designated symbol locations being positioned immediately diagonal to one another are “adjacent,” or simply that diagonal randomly designated symbol locations form another interaction trigger to further change the potential value of the symbols at such locations (e.g., increase a multiplier, etc.). Diagonally-positioned randomly designated symbol locations 420, 422 may result in any desired modification to the symbols therein, such as changing the symbols to wild symbols and providing associated multipliers (e.g., wild functionality with 2× multiplier), expansion of wild functionality to a block of wild symbols, linearly expanding wild symbols, or other desired result.

FIG. 4E depicts a “stacked” embodiment, where the same randomly designated symbol location on the slot game grid 424 is selected more than once. For example, in an embodiment where wild symbols are randomly positioned on the grid 424 to identify the randomly designated symbol locations, two such wild symbols end up on the same symbol location 426 in this example. Selection of the same randomly designated symbol location, such as by overlaying a plurality of special symbols on the randomly designated symbol locations, may result in any desired modification to the symbols therein, such as changing the symbols to wild symbols and providing associated multipliers (e.g., wild functionality with 2× multiplier), expansion of wild functionality to a block of wild symbols, linearly expanding wild symbols, or other desired result. In one embodiment, stacked symbols at a symbol location 426 is enhanced in a greater fashion than where the randomly designated symbol locations are at adjacent locations. For example, in the embodiment of FIG. 4E, stacked wild symbols at symbol location 426 may result in additionally applying a 10× multiplier to any winning paylines passing through symbol location 426, where adjacent wild symbols might only provide 4× multipliers (for example).

FIG. 4F depicts another embodiment where both an adjacency and stacking event occurs as a result of the randomly designated symbol locations. In an embodiment where wild symbols are randomly positioned on the grid 428 to identify the randomly designated symbol locations, two such wild symbols end up on the same randomly designated symbol location 430, which is then adjacent to another randomly designated symbol location 432. Rules for such a stacked plus adjacent situation may result in any desired modification to the symbols therein, such as changing the symbols to wild symbols and providing associated multipliers (e.g., wild functionality with 2× multiplier), expansion of wild functionality to a block of wild symbols, linearly expanding wild symbols, or other desired result. In one embodiment, stacked symbols at a randomly designated symbol locations such as symbol location 430 in addition to being adjacent to the randomly designated symbol location 432 may result in a greater enhancement than where the randomly designated symbol locations are only at adjacent locations without any stacking, or only where two wild symbols are stacked with no adjacency. For example, in the embodiment of FIG. 4F, stacked wild symbols at symbol location 430 with adjacency to symbol location 432 may result in additionally applying a 15× multiplier to any winning paylines passing through symbol location 430 and applying a 8× multiplier to any winning paylines passing through symbol location 432, where the multipliers would be less if there was not a situation of having both stacking and adjacency.

FIG. 4G depicts another embodiment where interaction rules are based on a predetermined pattern, or apply to a particular symbol location(s). In the example of FIG. 4G, the slot game grid 434 exhibits four randomly designated symbol locations, 436, 438, 440, 442. A rule may indicate that a pattern, such as four corners, is an interaction where enhancements to the symbols replacing/overlaying existing symbols at randomly designated symbol locations 436, 438, 440, 442 will occur. “Patterned” randomly designated symbol locations may result in any desired modification to the symbols therein, such as changing the symbols to wild symbols and providing associated multipliers (e.g., wild functionality with 2× multiplier), expansion of wild functionality to a block of wild symbols, linearly expanding wild symbols, or other desired result.

As previously indicated, the randomly designated symbol locations may be designated by highlighting the symbol locations, providing positional information (e.g., row 3, column 4), providing symbols or other indicia at the randomly designated symbol locations, etc. FIG. 4H depicts an example where symbols or other indicia migrate to or are otherwise made to appear at the randomly designated symbol locations. In the example of FIG. 4H, special symbols (depicted as star symbols) may be used to designate the symbol locations that will have symbol replacement and possible enhancement through modifiers or otherwise. In one embodiment, the symbols positioned at the randomly designated symbol locations are wild symbols, whereby they can be used for all (or some predetermined subset of all) symbols in the game's symbol set. Representative game play grid 444 includes one such wild symbol 446 at symbol location 448, and a pair of wild symbols 450, 452 at symbol location 454 (with wild symbols depicted as star symbols). Embodiments below implement similar “overlay” symbols, although the principles are equally applicable to other manners of randomly designating symbol locations for symbol replacement and possible modifier enhancement.

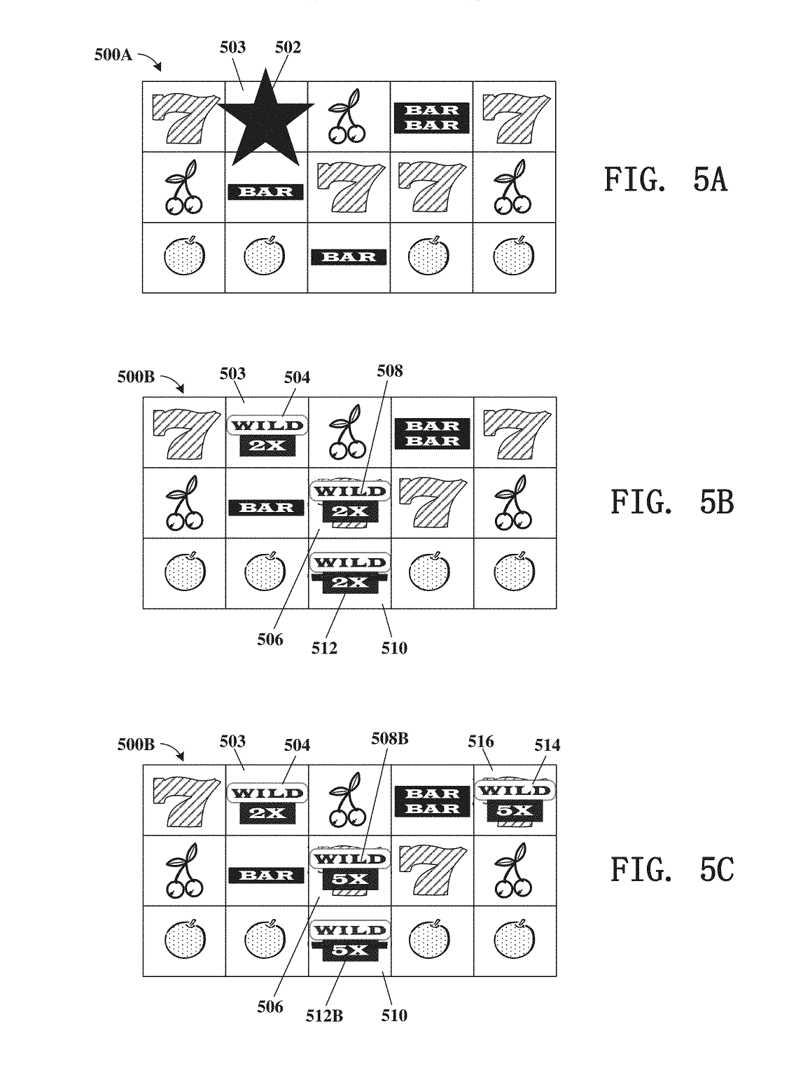

One embodiment involves varying the numbers of interacting overlays on the grid. The number of overlays on the grid could change between spins. A special symbol or other triggering event could “unleash” additional overlays onto the grid, to randomly designate additional symbol locations for enhanced symbol replacement. The feature could be used to create different payout awards on different spins, i.e., a short state game. FIGS. 5A and 5B depict such an embodiment where a special symbol enables the release of some number of overlays or other symbol location designators where initial symbols are supplanted by new symbols such as wild symbols.

In the embodiment of FIG. 5A, the random occurrence of one or more special symbols 502 on the game play grid 500A can trigger the release of a set number or a random number (based on rules) of overlays or other indicators to designate symbol locations for symbol replacement. FIG. 5A depicts an initial state of a gaming event, such as the immediately following a slot game spin, where a special symbol 502 is presented. The special symbol 502 initiates a second state of the gaming event shown in FIG. 5B, where one or more symbol overlays 504, 508, 512, are disseminated onto the game play grid 500B. The number of symbol overlays (or other symbol location symbol replacements) may be a predetermined number, may be a random number, may be dependent on another feature(s) of the game (e.g., dependent on other presented symbols or combinations), etc. In the illustrated embodiment, three overlay/replacement symbols occur as a result of occurrence of the special symbol 502 on grid 500A. In one embodiment, and overlay 504 may replace the special symbol 502 at symbol location 503 (as in the illustrated embodiment), but in other embodiments the unleashed symbol overlays may be entirely random as to their ultimate position. In one embodiment, paylines passing through symbol locations 503, 506, 510 will have a higher likelihood of obtaining a winning payout in view of the wild symbols 504, 508, 512, and would also enjoy a payout enhancement in view of the 2× multipliers associated with each of the wild symbols 504, 508, 512.

In another embodiment shown at FIG. 5C, interaction rules for the symbol overlays 504, 508, 512 come into play to potentially further enhance game payouts. In the example of FIG. 5C, an interaction rule, based on symbol overlay proximity, caused the modifier (multiplier) associated with adjacent overlay symbols 508, 512 to increase from its initial state. Particularly, the 2× wild symbols 508, 512 changed to 5× wild symbols 508B, 512B at symbol locations 506, 510 respectively, as a result of their adjacency and assumed interaction rules in this example. Another embodiment is to enable the spawning or further spawning of symbol overlays (or other symbol location symbol replacements) as a result of the interaction rules rather than as a result of a special symbol(s) or other initial trigger. Thus, some embodiments and variations may include providing additional overlay layers by spawning the additional overlay as a result of overlay adjacency state. This mechanism may be particularly well suited for a free games bonus. While the interaction rules may be set in any desired manner, Table 1 below shows one representative example of how the replacement symbol interaction rules may be used to spawn additional overlay or other replacement symbols:

TABLE 1

| INTERACTION STATE | ACTION |
|---|---|
| None adjacent | None |
| 2 adjacent but not overlaid | No additional overlays |
| 3 adjacent but not overlaid | No additional overlays |
| 2 overlaid | 1 new overlay is placed on random reels in |
| | random rows |
| 2 overlaid, 1 adjacent | 2 new overlays are placed on random reels in |
| | random rows |
| 3 overlaid | 3 new overlays are placed on random reels in |
| | random rows |

In such an embodiment, a situation with adjacent overlay symbols 508, 512 as shown in FIG. 5B could spawn one or more additional overlay symbols, such as depicted at symbol location 516 with a new 5× wild symbol 514 in FIG. 5C. Thus, interaction rules may instead or additionally result in the spawning of new overlay/replacement symbols.

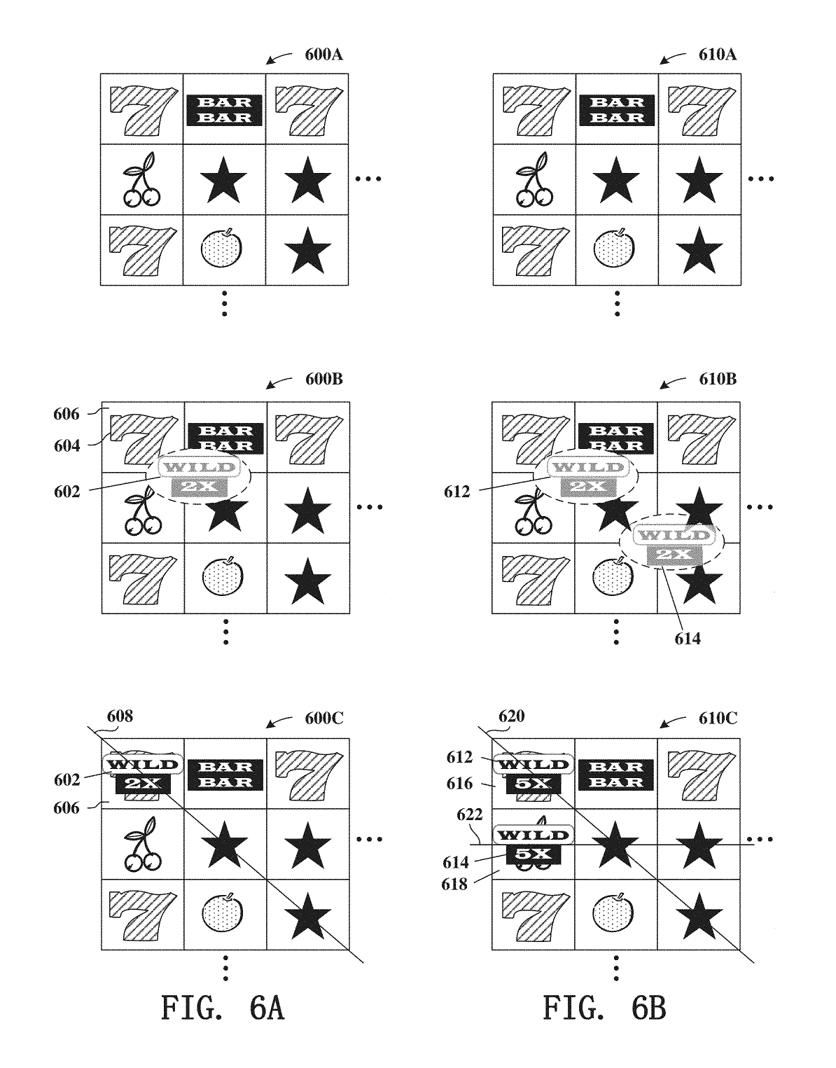

FIGS. 6A and 6B illustrate an example of how a symbol overlay as described herein can enhance gaming results based on symbol overlay interaction rules. FIG. 6A depicts a series of gaming stages, represented by gaming grids 600A, 600B and 600C, where no interaction between replacing symbol overlays occurs. Grid 600A shows an initial random placement of symbols on the grid 600A that may be any desired size. An overlay symbol 602 is made available as depicted on grid 600B. The game rules may indicate that overlay symbols will land on a particular reel/column for that spin, or may be confined to some other portion (e.g., row, corner, etc.), or may be entirely random. Also, the rules may indicate whether one, two, three or some other defined number of overlays may be presented for a particular spin or every spin, or alternatively the number of overlays may be random both in occurrence and number. In the illustrated embodiment of FIG. 6A at grid 600B, there is one overlay symbol 602 that is depicted as migrating to a final position, which in this case is to overlay/replace symbol 604 at symbol location 606. When overtaking symbol location 606, the overlay symbol (a 2× wild in this example) enables payline 608 to have a winning symbol combination of three stars. Assuming three stars pays fifty credits for the amount wagered, a payout of one hundred credits would be paid based on the 2× multiplier associated with the overlay symbol 602.

FIG. 6B, on the other hand, depicts a series of gaming stages, represented by gaming grids 610A, 610B, and 610C, where there is an interaction between replacing symbol overlays to enhance the payout of implicated winning paylines. Grid 610A shows an initial random placement of symbols on the grid 610A. In this embodiment, two overlay symbols 612, 614 are randomly presented. The overlay symbols 612 and 614 are depicted as migrating to respective final positions, which in this case overlay/replace existing symbols at symbol locations 616, 618 respectively.

Symbol overlay interaction rules enable further enhancements to be made. In this embodiment, it is assumed that an interaction rule increases a multiplier on the overlay symbols 612, 614 due to their ultimate adjacent positioning, as the overlay symbols 612, 614 are positioned in adjacent symbol positions 616, 618. This example increases the multiplier from a default 2× (two times) multiplier to a 5× (five times) multiplier. These overlay symbols 612, 614 each enable paylines implicated by their respective symbol locations 616, 618 to have a higher chance of obtaining an award (due to the wild functionality) and to increase the potential payout upon a winning symbol combination (due to the increased multiplier). In this embodiment, the overlay symbols 612, 614 in symbol locations 616, 618 caused paylines 620 and 622 to have winning symbol combinations (three star symbols) and a 5× multiplier on each payline. Assuming three stars pays 50 credits for the amount wagered, a payout of 250 credits would be paid for each payline (50 credits times 5× multiplier), for a total of 500 credits.

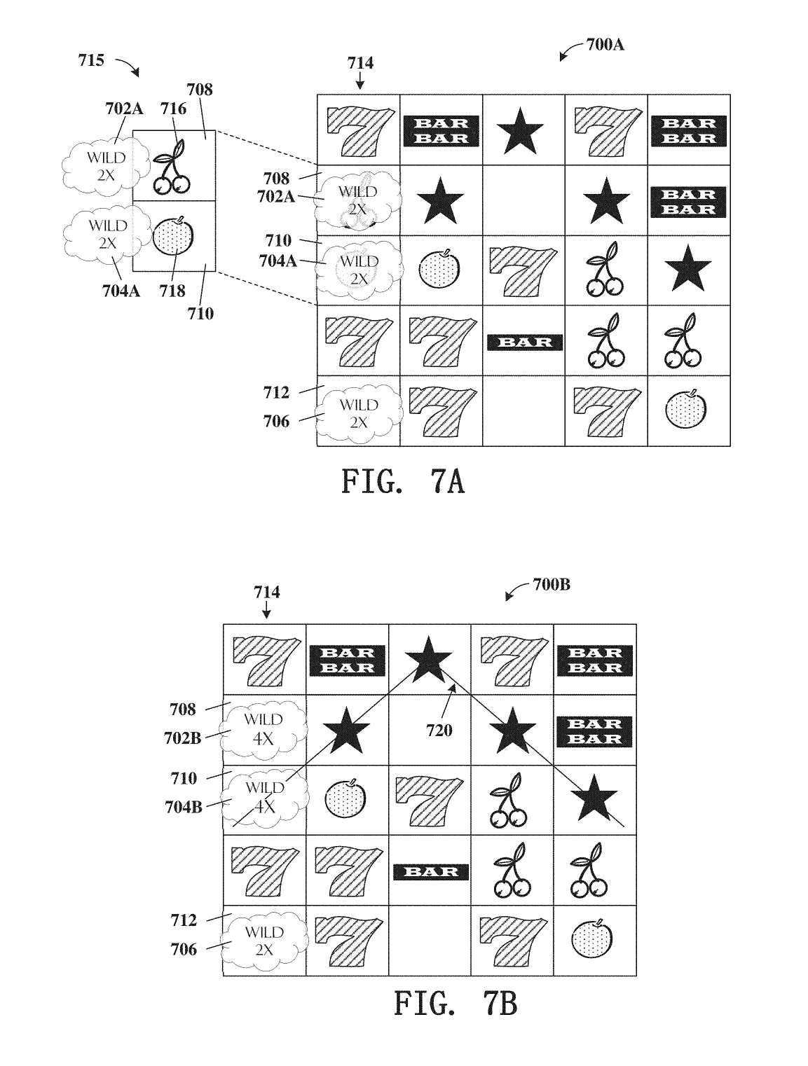

Other different representative embodiments of symbol replacement and interaction enhancements are now described. FIGS. 7A and 7B illustrate an embodiment where a predetermined number of symbol overlays are available on a common reel. FIG. 7A depicts a 5×5 slot game grid 700A for ease of description, although any size grid could be used. For example, in one embodiment (not shown), the grid 700A is a 9×5 grid, having nine rows and five columns. In this embodiment, there are three symbol overlays 702A, 704A and 706 that are randomly placed over symbols in symbol locations 708, 710, 712 respectively, on a single reel 714. The single reel may be the same reel for each spin, or may be randomly selected on each spin (or every X spins), or may follow a pattern such as cycling through each of the reels, etc. This embodiment, however, involves utilizing a fixed number of overlays on a single reel for each spin, such that all three overlay symbols will be moved on each spin. Thus, the reel including the overlay symbols may change between spins, but all three overlay symbols will occupy the same reel in this example.

Symbol locations 708 and 710 are also shown as a breakout section 715, to show that the overlay symbols 702A and 704A replace initial symbols 716, 718 respectively. The default value of the overlay symbols 702A, 704A in this example are wild symbols with 2× (two times) multipliers, but other overlay symbols and/or modifiers may be used. Thus, each overlay symbol 702A, 704A causes the respective symbol 716, 718 below it to become a 2× Wild.

In accordance with the principles described herein, interaction rules may then assess the state of the overlay symbols 702A, 704A, 706 to determine an interaction that occurred in response to their placement on the grid 700A. Table 2 below is an example of interaction rules that may be applied in this example:

TABLE 2

| INTERACTION STATE | ACTION |
|---|---|
| None adjacent | Symbol under assigned 2x multiplier wild |
| 2 adjacent but not overlaid | Symbol under each assigned a 4x multiplier |
| | wild |
| 3 adjacent but not overlaid | Symbol under each assigned a 6x multiplier |
| | wild |
| 2 overlaid | Symbol under assigned 10x multiplier wild |
| 2 overlaid, 1 adjacent | Symbol under overlaid assigned 12x |
| | multiplier, symbol under adjacent assigned |
| | 5x multiplier |
| 3 overlaid | Symbol under assigned 20x multiplier wild |

For example, if two overlay symbols 702A, 704A (for example) happened to come to rest on the same symbol location, this is an interaction state of “2 overlaid” overlay symbols, with an action to change the symbol at that symbol location to a 10× Wild (i.e. a wild symbol with a ten times multiplier for winning paylines passing through that symbol location). In this example, overlay symbols 702A and 704A are in adjacent symbol locations 708, 710, which in the defined rules of Table 2 have an interaction state of “2 adjacent but not overlaid,” and a resultant action of assigning a 4× Wild symbol to the symbol location. This is seen on grid 700B of FIG. 7B, where overlay symbols 702A and 704A have changed to 4× Wild overlay symbols 702B and 704B respectively. Thus, any winning payout on a payline passing through either symbol location 708, 710 will receive a four times multiplier in this example. For example, assuming five star symbols in a row on payline 720 provide a 50 credit award, the final payout for that payline 720 will be 200 credits (50 credits×multiplier of 4). Because the overlay symbol 706 at symbol location 712 did not conform to any of the defined interaction states for this example, it remains as a 2× Wild symbol 706 without undergoing any further change.

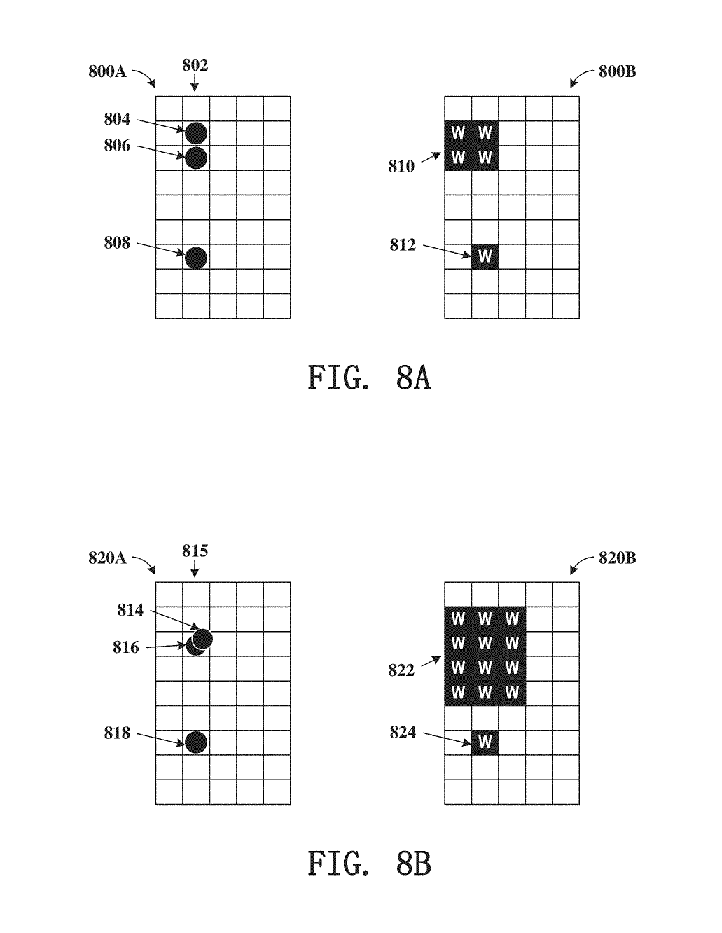

Other embodiments include adjacent or overlaid symbols creating expanding wilds, progressive pays, feature initiation/bonus initiations, etc. FIGS. 8A and 8B depict alternative embodiments where overlay/replacement symbol interaction rules provide expanding block wild actions. This example assumes a 9×5 slot grid, although any size grid may be used. In the example of FIG. 8A, three symbol overlays 804, 806 and 808 are randomly presented on a reel 802 of the grid 800A. In one embodiment, interaction rules cause a block 810 of wild symbols to occur, such as shown at the resulting grid 800B. A multiplier or other modifier value may be associated with each of the wild symbols in the block 810 of wild symbols, and may be a greater multiplier than a single overlay. Symbol 808 of grid 800A may retain the default action for a single overlay, which may be no multiplier value, a 2× multiplier value, etc. An example of a set of interaction rules for a block wild embodiment such as that of FIG. 8A is shown in Table 3 below.

TABLE 3

| INTERACTION STATE | ACTION |
|---|---|
| None adjacent | 3 1 × 1 wilds |
| 2 adjacent but not overlaid | 2 × 2 and 1 × 1 wild |
| 3 adjacent but not overlaid | 3 × 3 wild |
| 2 overlaid | 3 × 4 and 1 × 1 wild |
| 2 overlaid, 1 adjacent | 4 × 4 wild |
| 3 overlaid | 6 × 5 wild |

As can be seen, two adjacent overlays in this example would provide a 2×2 block wild (i.e. two in a first direction and two in a second direction for a total of 4 wild symbols, such as block 810 of grid 800B).

FIG. 8B illustrates another example using Table 3 as the interaction rules, where two symbols 814, 816 are overlaid at a single symbol location on grid 820A. Three symbol overlays 814, 816, 818 are randomly presented on a reel 815 of the grid 820A. As shown in representative Table 3, two overlaid symbols results in a 3×4 block wild, with the remaining symbol overlay 818 being a standard 1×1 wild (i.e. a wild at a single symbol location). This is depicted at the resulting grid 820B, where the overlaid symbols 814, 816 are converted to a 4×3 block 822 of wild symbols, and the remaining overlay symbol 818 provides a single wild symbol 824. If payout modifiers (e.g., multipliers) are also part of the interaction rules, modifiers associated with the block 822 of wild symbols are larger than those associated with single wild symbols 824 in one embodiment.

If a single wild symbol 824 happens to fall within a block 822 of wild symbols (e.g., due to the symbol 818 being higher by two symbol locations), the single wild symbol 824 may be effectively disregarded since the block 822 of wild symbols encompasses the single wild symbol 824. In other embodiments, the single wild symbol 824 may be awarded a higher modifier if encompassed by the block 822 of wild symbols, or may be moved elsewhere, etc.

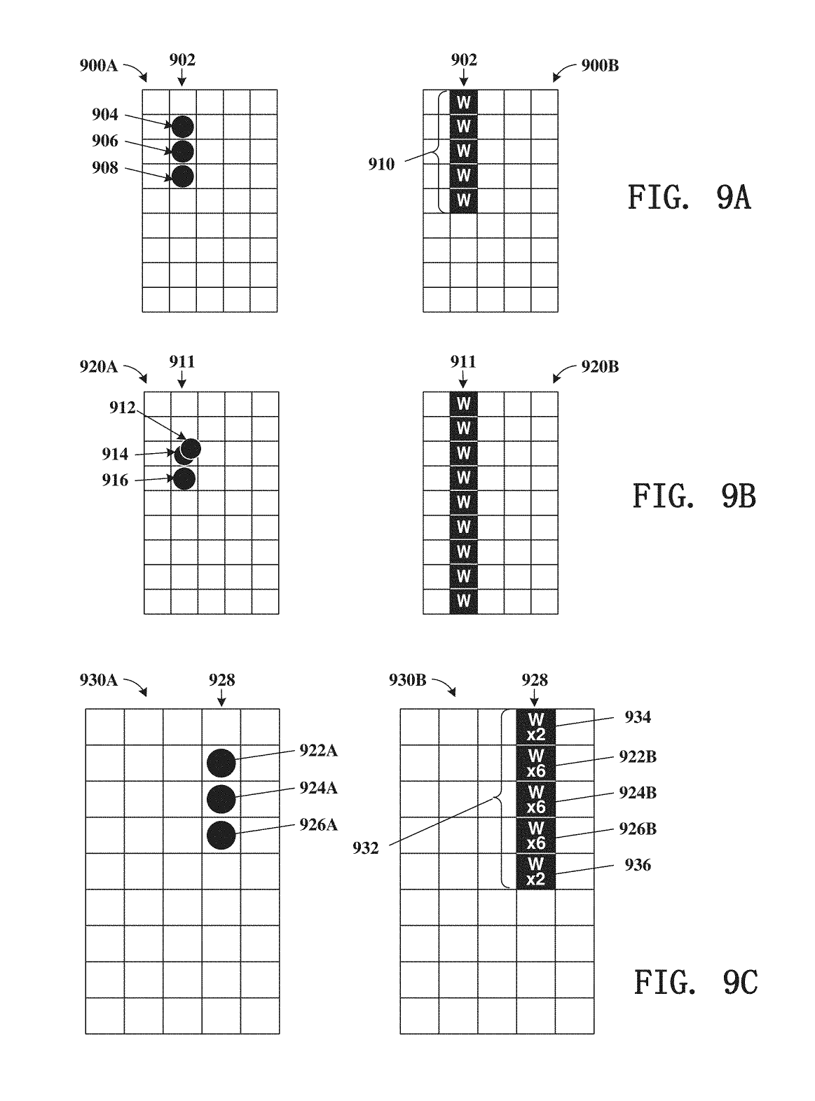

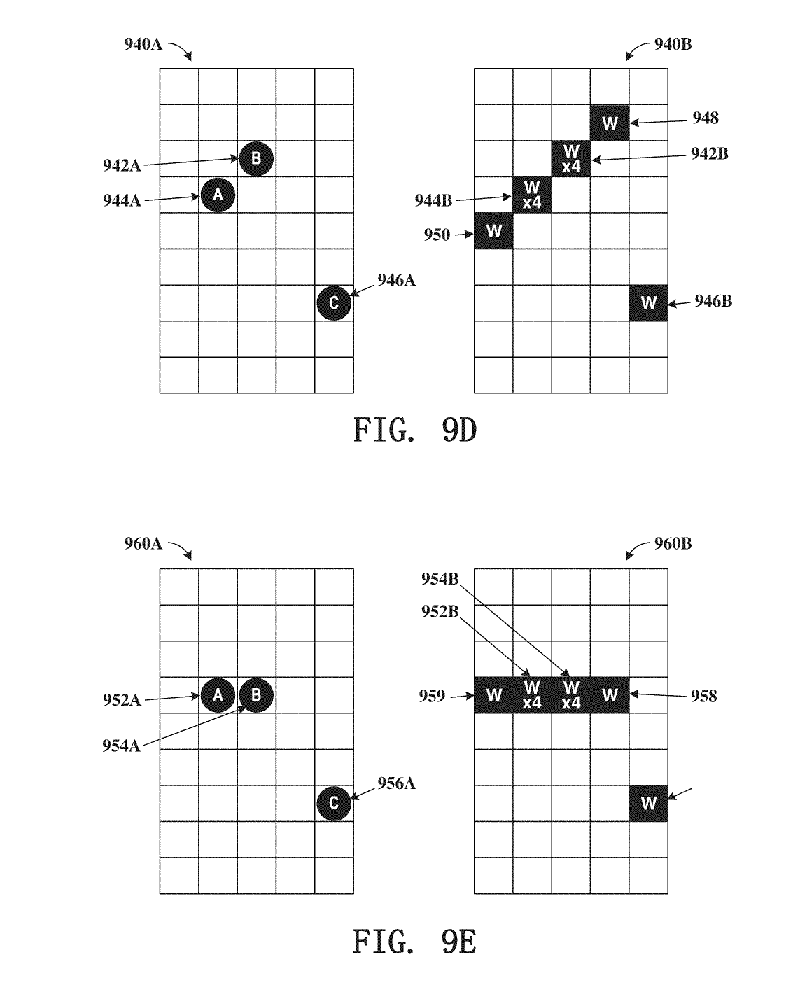

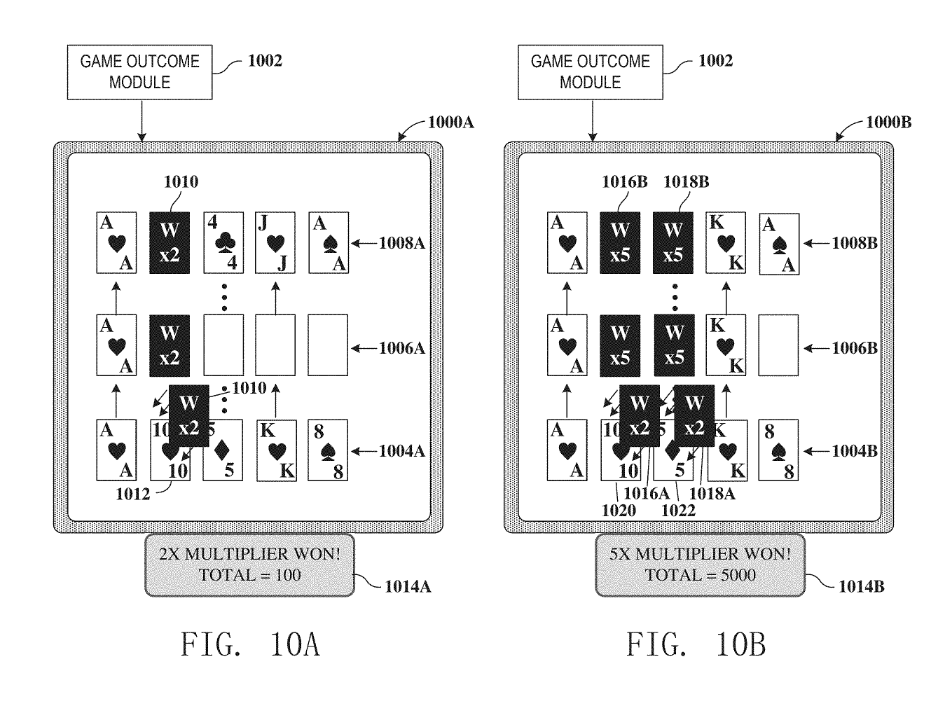

Other embodiments include adjacent or overlaid symbols creating linearly expanding wilds, such as depicted in FIG. 9A. This example assumes a 9×5 slot grid, although any size grid may be used. In the example of FIG. 9A, three symbol overlays 904, 906, 908 are randomly presented on a reel 902 of the grid 900A. In one embodiment, interaction rules cause a line 910 of wild symbols to occur, such as shown at the resulting grid 900B. The linearly expanding wilds may expand to a nearest border, the farthest border, a fixed number, a random number, or however defined. In one embodiment, the extent of the expansion is dependent on the interaction rules, and the proximity of the randomly-presented symbol overlays. A multiplier or other modifier value may be associated with each of the wild symbols in the line 910 of wild symbols, and may be a greater multiplier than a single overlay. FIG. 9B shows another example where two overlay symbols 912, 914 are overlaid on a single symbol location, and overlay symbol 916 is in a symbol location adjacent to the pair of overlaid symbols 912, 914. In one embodiment the resulting linearly expanding wilds extend through the entire reel 911. Representative examples of sets of interaction rules for a linearly expanding wild embodiment such as that of FIGS. 9A and 9B are shown in Tables 4 and 5 below, which may be further enhanced with multipliers or other modifiers.

TABLE 4

| INTERACTION STATE | ACTION |
|---|---|
| None adjacent | None |
| 2 adjacent but not overlaid | Stack of 3 wild symbols high |
| 3 adjacent but not overlaid | Stack of 5 wild symbols high |
| 2 overlaid | Stack of 7 wild symbols high |
| 2 overlaid, 1 adjacent | Stack of 9 wild symbols high |
| 3 overlaid | Stack of 9 high, and expand to the sides |
| | if possible (e.g., expand to left and/or |
| | right border) |

TABLE 5

| INTERACTION STATE | ACTION |
|---|---|
| None adjacent | None |
| 2 adjacent but not overlaid | Stack of 6 wilds is created; overlays retain |
| | multipliers |
| 3 adjacent but not overlaid | Stack of 9 wilds is created; overlays retain |
| | multipliers |
| 2 overlaid | Stack of 6 wilds is created; overlays retain |
| | multipliers |
| 2 overlaid, 1 adjacent | Stack of 6 wilds is created; overlays retain |
| | multipliers |
| 3 overlaid | Entire reel is filled with multiplier wilds |

Still other embodiments may involve block wilds and/or linearly expanding wilds, where the interaction rules further adjust modifier values on the resulting wild symbols. FIG. 9C is an example where the interaction rules create a linearly expanding group of wild symbols with at least two different multiplier values. This example assumes a 9×5 slot grid, although any size grid may be used. In the example of FIG. 9C, three symbol overlays 922A, 924B, 926C are randomly presented on a reel 928 of the grid 930A. In one embodiment, interaction rules cause a line 932 of wild symbols to occur, such as shown at the resulting grid 930B. Additionally, those replacement wild overlay symbols 922B, 924B and 926B that respectively overlay/replace original symbols 922A, 924A and 926A are given a first modifier value, which is a 6× (six times) multiplier in this example. The interaction rules further indicate that, in the situation where three overlays 922A, 924A, 926A are adjacent to one another, at least one additional wild overlay will be included. Such additional wild overlays in this example include wild 934 and 936, which were added at each end of the expanding line (although alternatively could be added to just one end). These additional wild overlay symbols 934 and 936 are also provided a multiplier value in this example, but are provided with a second modifier value that is lower than the first modifier value. For example, the additional wild overlay symbols 934 and 936 may be provided with a 2× multiplier, where the wild overlay symbols 922B, 924B and 926B that respectively overlay/replace original symbols 922A, 924A and 926A were given a 6× multiplier. Table 6 below provides a representative example of a set of interaction rules for a linearly expanding wild embodiment that is further enhanced with location-dependent modifiers.

TABLE 6

| INTERACTION STATE | ACTION |
|---|---|
| None adjacent | Symbol under assigned 2x multiplier wild |
| 2 adjacent but not | Symbol under each assigned a 4x multiplier |
| overlaid | wild, symbol above and below adjacent |
| | symbols assigned a 1x wild creating a stack |
| | of 4 wilds |
| 3 adjacent but not | Symbol under each assigned a 6x multiplier |
| overlaid | wild, symbol above and below adjacent symbol |
| | assigned a 2x wild creating a stack of 5 wilds |
| 2 overlaid | Symbol under assigned 10x multiplier wild, 2 |
| | symbols above and below overlaid symbols |
| | assigned a 3x wild creating a stack of 3 wilds |
| 2 overlaid, 1 adjacent | Symbol under overlaid assigned 12 multiplier, |
| | symbol under adjacent assigned 5x multiplier, |
| | symbols above and below assigned a 2x |
| | multiplier wild creating a stack of 4 wilds |
| 3 overlaid | Symbol under assigned 20x multiplier wild, |
| | all other symbols in reel assigned a 2x |
| | multiplier wild |

Embodiments described herein may apply to symbols that are adjacent, but not necessarily in the same reel or column, as numerous examples have already noted. FIGS. 9D and 9E illustrate examples where the interaction rules create a wild expansion and varying modifier values, where the overlay symbols are not restricted to a single reel/column.

FIG. 9D is an example where the interaction rules create an expanding group of wild symbols with at least two different multiplier values, where the overlay symbols are not restricted to a single reel. This example assumes a 9×5 slot grid, although any size grid may be used. In the example of FIG. 9D, three symbol overlays 942, 944B, 946C are randomly presented anywhere on the grid 940A. In one embodiment, interaction rules cause an expansion of the line originally formed by symbols 942A and 944A, as these two symbols are deemed adjacent in this example. This expanded line is shown at the resulting grid 940B, and includes overlay symbols 942B and 944B, as well as two new wild symbols 948, 950 that resulted from the expansion of wild symbols as set forth in the interaction rules assumed for this example. Overlay symbols 942B and 944B are modified to a 4× Wild symbol according to the interaction rules, while the added wild symbols 948, 950 are not provided with any increased modifier in this example. Therefore, winning paylines passing through the symbol locations where symbols 942B or 944B reside will be multiplied by four, while winning paylines passing through the symbol locations where new overlay symbols 948 or 950 reside will not be multiplied by anything. Table 6 above provides an example of a set of interaction rules for a linearly expanding wild embodiment that is further enhanced with location-dependent modifiers.

FIG. 9E is another example where the interaction rules create an expanding group of wild symbols with at least two different multiplier values, where the overlay symbols are not restricted to a single reel. This example is similar to that of FIG. 9D, but where the adjacent symbols on grid 960A are positioned horizontally. The three symbol overlays 952A, 954A and 956A are randomly presented anywhere on the grid 960A. In one embodiment, interaction rules cause an expansion of the line originally formed by symbols 952A and 954A, as these two symbols are adjacent. This expanded line is shown at the resulting grid 960B, and includes overlay symbols 952B and 954B, as well as two new wild symbols 958 and 959 that resulted from the expansion of wild symbols as set forth in the interaction rules assumed for this example. Overlay symbols 952B and 954B are modified to a 4× Wild symbol according to the interaction rules, while the added wild symbols 958, 959 are not provided with any increased modifier in this example. Therefore, winning paylines passing through the symbol locations where symbols 952B or 954B reside will be multiplied by four, while winning paylines passing through the symbol locations where new overlay symbols 958 or 959 reside will not be multiplied by any multiplier.

In one particular embodiment now described for purposes of example, a slot game is provided for enhancing initial reel spin results via symbol replacement, on a slot grid having a larger number of rows than columns. For example, one representative slot grid may be a 12×5 grid (12 rows, 5 columns/reels). In such an embodiment, the game may select one of the five reels in which to confine the random placement of symbol enhancements. For example, one of the five reels may be selected using a weighted draw, and the selected reel then becomes the target of the multiple (three in this example) wild symbols that will be positioned thereon. Additionally, the wild symbols may use a weighted draw to determine their respective positions on the selected reel. In one embodiment, there is a multiplier assigned to the wild symbols. If any of the positioned wild symbols are adjacent to one another, the original multipliers on those adjacent wild symbols are increased, and that reel fills with wild symbols. If any of the positioned wild symbols overlay one another, the original multipliers are increased further at the locations of the overlay, and the reel fills with wild symbols. In one embodiment, the wild symbols migrate between reels (or can stay or migrate back to the same reel) on each reel spin. Therefore, in embodiments where the wild symbols are provided on a single reel/column, any desired manner of selecting the reel and reel positions may be used, although in one embodiment this is handled with weighted draws. In some embodiments, a trigger can increase the number of reels and/or wild symbols used in the feature. For example, one embodiment involves a “second reel trigger” which may be, for example, a scatter bonus of three symbols on particular reels or anywhere on the grid. If this occurs, then on the next reel spin (or the next N reel spins, or some time, etc.), an additional reel will be provided with the wild symbols. In such a case, the second reel may again be randomly selected, and again the positions of the wild symbols may be randomly selected, in any desired manner including weighted draws.

As previously noted, other embodiments may include progressive pays, feature initiation/bonus initiations, etc. In the case of progressive pays, the interaction rules may allow a player to win a progressive jackpot, or one or more of a plurality of progressive jackpots, based on the interaction of the overlay symbols. Table 7 shows one representative example for awarding progressive jackpots as a result of interaction states of overlay symbols as described herein.

TABLE 7

| INTERACTION STATE | ACTION |
|---|---|
| None adjacent | None |
| 2 Adjacent but not overlaid | P5 (5^{th} level progressive - smallest) |
| 3 Adjacent but not overlaid | P4 (4^{th} level progressive) |
| 2 overlaid | P3 (3^{rd} level progressive) |
| 2 overlaid, 1 adjacent | P2 (2^{nd} level progressive) |
| 3 overlaid | P1 (1^{st} level/top progressive - largest) |

The example of Table 7 assumes five progressive jackpot levels, with P1 being the top progressive jackpot, ranging down to P5 which is the smallest progressive jackpot. Based on the interaction rules of the overlay symbols, which is proximity of the overlay symbols in this example, progressive jackpots may be awarded to the player. For example, in a 9×5 grid (i.e., 9 rows, 5 reels), if the player's spin populated the slot game grid, and 3 overlay symbols were randomly positioned on reel 3 and were all overlaid at the same symbol location, the player would be awarded the top progressive award, P1.

Another example uses interaction rules to provide bonuses, free games, or other gaming features associated with the game. In the case of a free games bonus, the interaction rules may allow a player to win various numbers of free games or free spins. Table 8 shows one representative example for awarding free spins as a result of interaction states of overlay symbols as described herein.

TABLE 8

| INTERACTION STATE | ACTION |
|---|---|
| None adjacent | None |
| 2 adjacent but not overlaid | 5 free games initially awarded |
| 3 adjacent but not overlaid | 10 free games initially awarded |
| 2 overlaid | 15 free games initially awarded |
| 2 overlaid, 1 adjacent | 25 free games initially awarded |
| 3 overlaid | 50 free games initially awarded |

The principles described herein are equally applicable to other games of chance, such as poker, bingo, etc. FIGS. 10A and 10B illustrate a poker embodiment that utilizes symbol overlay interaction rules to increase the chances of a winning result and/or higher payouts. Thus, in the illustrated embodiment, FIGS. 10A and 10B illustrate another representative embodiment of a game employing systems and methods for enhancing gaming awards using random enhancers, which may be further enhanced due to their relative interaction with one another. FIG. 10A depicts a representative draw poker game presented on a gaming display 1000A. The game outcome module 1002 may represent the software-programmed or otherwise configured hardware to specify a given one or more game combination results, such as poker hands, stud poker hands, hold-em poker hands, or any other card game hands. The game outcome module 1002 may include the game probability configuration parameters such as the number of card decks, the number of each card in each deck, and/or other indicia on the cards. These variables provide a natural probability of occurrence of any of the game combination results associated with that card/gaming event. The game outcome module 1002 also represents the game combination generation and determination functions which generates one or more card hands, and selects the original cards/hands, any replacement cards/hands (e.g., draw cards), etc. to produce game outcomes.

In the example of FIG. 10A, an original hand 1004A is dealt, that by chance includes an Ace of Hearts (A-H), Ten of Hearts (10-H), Five of Diamonds (5-D), King of Hearts (K-H), and Eight of Spades (8-S). As this example is a draw poker embodiment, the player is allowed to retain or “hold” one or more cards of the original hand 1004A. In this example, the player holds the A-H, and discards the 5-D, K-H and 8-S as depicted at intermediate hand 1006A. In this embodiment, an overlay 1010 is provided, which is a 2× wild (wild functionality with multiplier of 2) that supplanted the 10-H card 1012. In this embodiment, this overlay 1010 removes the need to discard the original 10-H card 1012. When the discarded cards are replaced to provide a final hand 1008A, the best payout available for the cards of the final hand 1008A are three aces, including the A-H, the overlay 1010, and the Ace of Spaces (A-S), which is assumed to pay fifty (50) credits in this example. With the 2× multiplier 1010, the total payout is 100 credits.

The example of FIG. 10B shows an example of when multiple overlays 1016A, 1018A are provided, which can then potentially interact to provide even greater enhancements. This example assumes the same starting hand, shown in FIG. 10B as original hand 1004B. Overlays 1016A and 1018A become associated with original 10-H card 1020 and 5-D card 1022, beginning with a default (in this example) of a 2×-wild functionality. In one embodiment, because there is a proximity interaction of the overlays 1016A, 1018A being adjacent to one another, the enhancement function is further increased to make both overlays 1016B, 1018B in the final hand 1008B 5×-wild functionalities. Therefore, the adjacency of the originally-presented overlays 1016A and 1018A enables an increased enhancement function as depicted by resulting overlays 1016B and 1018B. In one embodiment, the highest multiplier in the final hand 1008B may be used (e.g., a 5× multiplier). In such an embodiment, if the credit payout for four aces was 1000 credits, the final payout would be 5000 credits as depicted at display window 1014B. Other interaction rules may alternatively or additionally be in effect. For example, if the two overlays 1016A and 1018A had stacked upon a single card, the multiplier may be further enhanced to, for example, 10×, and wild functionality could branch out, etc. As can be seen, the interaction rules described herein can be applied to other games.

The features described herein can be used in connection with any game of chance, including slot games, poker games, keno, roulette, bingo, and the like. They may be provided using physical structures, or electronic structures created in computing hardware and displayed as virtual structures of such physical structures. The gaming events described herein may be provided as a base game of chance or an auxiliary gaming event such as a bonus event, free spin event, or other secondary event.

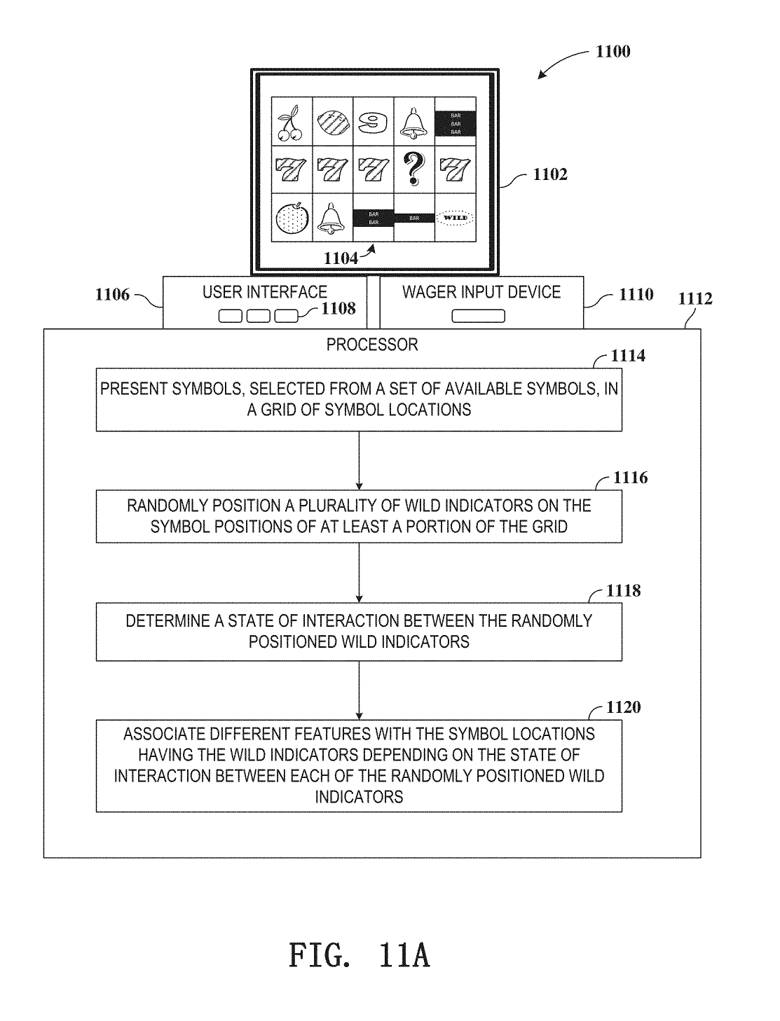

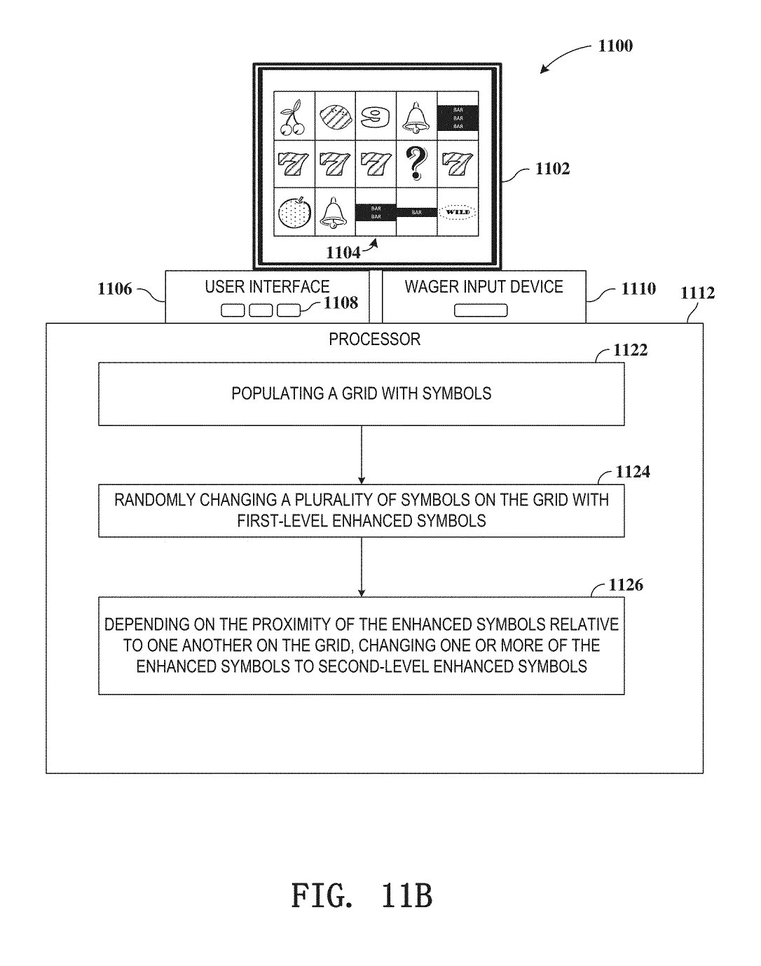

FIGS. 11A and 11B are block diagrams of representative alternative slot game apparatuses for using interactive enhancement elements in accordance with the disclosure. In the embodiment of FIG. 11A, a slot game device 1100 is provided on which players can play slot games. The representative slot game device 1100 includes at least a display 1102 presenting a slot game symbol array or “grid” 1104 of symbol locations, a user interface 1106 including at least one user input 1108 to enable a player to initiate a slot game event presented via the slot game grid 1104, and a wager input device 1110 structured to identify and validate player assets and ultimately permit the player to play the slot game event when the player assets are provided. The slot game device 1100 also includes a processor 1112 configured to present symbols, selected from a set of available symbols, in a grid of symbol locations, randomly position multiple wild indicators on the symbol positions of at least a portion of the grid, determine a state of interaction between the randomly positioned wild indicators, and associate different features with the symbol locations having the wild indicators depending on the state of interaction between each of the randomly positioned wild indicators.

The slot game device 1100 configures the processor 1112 (which may include one or more cooperative processing devices) to structurally program functional elements into hardware modules. Processor 1112 circuitry configuration thus changes based on the modules developed by software to carry out the desired methodology. For example, the processor 1112 is programmed by software/code to create a hardware-based module to activate 1114 the payout enhancement feature and to create other such software/code modules for each of the operations 1114-1126.

Other structural modules may be created on the slot game device using a properly configured processor 1112. Referring now to the example of FIG. 11B, the processor 1112 may be configured into programmed modules to populating the grid with symbols, randomly changing a plurality of symbols on the grid with first-level enhanced symbols, and depending on the proximity of the enhanced symbols relative to one another on the grid, changing one or more of the enhanced symbols to second-level enhanced symbols. In one embodiment, the first-level enhanced symbols are of higher gaming value than the symbols populating the grid, and the second-level enhanced symbols are of higher gaming value than the first-level enhanced symbols.

The foregoing description of the representative embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above.

What is claimed is:

1. A game apparatus for enhancing gaming awards in a slot game utilizing symbols in respective symbol locations of a symbol grid to determine payouts, comprising:
a display presenting the symbol locations of the symbol grid;
a user interface including at least one user input to enable a player to at least initiate a slot game event presented via the symbol array;
a wager input device structured to identify and validate player assets, and to permit the player to play the slot game event when the player assets are provided; and
a processor configured to:
present symbols, selected from a set of available symbols, in the symbol grid of the symbol locations;
randomly position a plurality of wild indicators on the symbol locations of at least a portion of the symbol grid;
determine a state of interaction between the wild indicators; and
associate different features with the symbol locations having the wild indicators depending on the state of interaction between each of the wild indicators.

2. The game apparatus as in claim 1, wherein the processor is configured to determine the state of interaction as a proximity of the wild indicators to one another.

3. The game apparatus as in claim 2, wherein the processor is configured to determine the state of interaction as an adjacency of the wild indicators to one another.

4. The game apparatus as in claim 2, wherein the processor is configured to determine the state of interaction as a stacking of the wild indicators at a common one of the symbol locations.

5. The game apparatus as in claim 2, wherein the processor is further configured to associate increasingly higher payout modifiers with the symbol locations having the wild indicators as the distance between the wild indicators on the symbol grid decreases.

6. The game apparatus as in claim 1, wherein the processor is configured to associate different features with the symbol locations having the wild indicators by associating different values of multipliers with the symbol locations having the wild indicators depending on the state of interaction between each of the wild indicators.

7. The game apparatus as in claim 1, wherein the wild indicators are each assigned respective default multiplier values, and wherein the processor is configured to associate the different features by updating the default multiplier values if the state of interaction between the wild indicators obtains a predefined state.

8. The game apparatus as in claim 1, wherein the processor is configured to randomly position the plurality of wild indicators on the symbol locations of at least a portion of the symbol grid by randomly positioning overlay wild symbols on the symbol locations.

9. The game apparatus as in claim 1, wherein the processor is configured to randomly position the plurality of wild indicators on the symbol locations of at least a portion of the symbol grid by substituting the wild indicators for the symbols existing at the symbol locations of the wild indicators.

10. The game apparatus as in claim 1, wherein the processor is configured to randomly position the plurality of wild indicators on the symbol locations within a single column of the slot game.

11. The game apparatus as in claim 1, wherein the processor is configured to randomly position the plurality of wild indicators on the symbol locations in any of the symbol locations of the symbol grid.

12. The game apparatus as in claim 1, wherein the processor is configured to associate different features with the symbol locations having the wild indicators by spawning new randomly-positioned wild indicators if the state of interaction obtains a predefined state.

13. A game apparatus for enhancing gaming awards in a slot game utilizing symbols in respective symbol locations of a symbol grid to determine payouts, comprising:
a display presenting the symbol locations of the symbol grid;
a user interface including at least one user input to enable a player to at least initiate a slot game event presented via the symbol array;
a wager input device structured to identify and validate player assets, and to permit the player to play the slot game event when the player assets are provided; and
a processor configured to:
populate a grid with symbols;
randomly changing a plurality of symbols on the grid with first-level enhanced symbols; and
depending on the proximity of the enhanced symbols relative to one another on the grid, changing one or more of the enhanced symbols to second-level enhanced symbols.

14. The game apparatus of claim 1, wherein the first-level enhanced symbols are of higher gaming value than the symbols populating the grid, and the second-level enhanced symbols are of higher gaming value than the first-level enhanced symbols.

15. The game apparatus of claim 1, wherein the processor is configured to determine the proximity of the enhanced symbols relative to one another on the grid, and to change one or more of the enhanced symbols to second-level enhanced symbols when the processor determines the proximity of the enhanced symbols to be in adjacent ones of the symbol locations.

16. The game apparatus of claim 1, wherein the processor is configured to determine the proximity of the enhanced symbols relative to one another on the grid, and to change one or more of the enhanced symbols to second-level enhanced symbols when the processor determines the proximity of the enhanced symbols to be in adjacent ones of the symbol locations on the same visible portion of the slot game reel.

17. The game apparatus of claim 1, wherein the processor is configured to determine the proximity of the enhanced symbols relative to one another on the grid, and to change one or more of the enhanced symbols to second-level enhanced symbols when the processor determines the proximity of the enhanced symbols to be stacked in a common one of the symbol locations.

18. The game apparatus of claim 1, wherein the second-level enhanced symbols comprise an increased number of the symbols than a number of the first-level enhanced symbols.

19. A method for enhancing gaming payouts, comprising:
populating a slot game grid with symbols;
randomly changing a plurality of symbols on the grid with first-level enhanced symbols;
determining the relative positions on the slot game grid of the first-level enhanced symbols;
if the relative positions of the first-level enhanced symbols are determined to be in adjacent ones of the symbol locations, updating the first-level enhanced symbols to second-level enhanced symbols;
if the relative positions of the first-level enhanced symbols are determined to be in a same one of the symbol locations, updating the first-level enhanced symbols to third-level enhanced symbols; and
analyzing the slot game grid to determine payouts in view of any one or more of the symbols, the first-level enhanced symbols, the second-level enhanced symbols, and the third-level enhanced symbols.
